(19) United States
(12) Patent Application Publication
(10) Pub. No.: US 2012/0200851 A1
(43) Pub. Date: Aug. 9, 2012

(54) RAMAN SPECTROSCOPY LIGHT AMPLIFYING STRUCTURE

(76) Inventors: Wei Wu, Palo Alto, CA (US); Jingjing Li, Palo Alto, CA (US); Zhiyong Li, Redwood City, CA (US); Shih-Yuan (SY) Wang, Palo Alto, CA (US); Alexandre M. Bratkovski, Mountain View, CA (US)

(21) Appl. No.: 13/384,866

(22) PCT Filed: Oct. 23, 2009
(86) PCT No.: PCT/US09/61904

§ 371 Date: Jan. 19, 2012

(51) Int. Cl. G01J 3/44

(52) U.S. Cl. 356/301

(57) ABSTRACT

A light amplifying structure 100 for Raman spectroscopy includes a a resonant cavity 108. A distance between a first portion 102B and a second portion 102A of the structure 100 forming the resonant cavity 108 is used to amplify excitation light emitted from a light source 420 into the resonant cavity 108 at a first resonant frequency of the resonant cavity 108. Also, the resonant cavity 108 amplifies radiated light radiated from a predetermined molecule excited by the excitation light in the resonant cavity at a second resonant frequency of the resonant cavity 108.

### FEDERALLY SPONSORED RESEARCH OR DEVELOPMENT

The U.S. Government has a paid-up license in this invention and the right in limited circumstances to require the patent owner to license others on reasonable terms as provided for by the terms of contract number HR0011-09-3-0002 awarded by DARPA.

### BACKGROUND

Raman spectroscopy is a well-known spectroscopic technique for performing chemical analysis. In conventional Raman spectroscopy, high intensity monochromatic light provided by a light source, such as a laser, is directed onto an analyte (or sample) that is to be chemically analyzed. The analyte may contain a single molecular species or mixtures of different molecular species. Furthermore, Raman spectroscopy may be performed on a number of different types of molecular configurations, such as organic and inorganic molecules in either crystalline or amorphous states.

The majority of the incident photons of the light are elastically scattered by the analyte molecule. In other words, the scattered photons have the same frequency, and thus the same energy, as the photons that were incident on the analyte. However, a small fraction of the photons (i.e., 1 in 10⁷ photons) are inelastically scattered by the analyte molecule. These inelastically scattered photons have a different frequency than the incident photons. This inelastic scattering of photons is termed the “Raman effect.” The inelastically scattered photons may have frequencies greater than, or, more typically, less than the frequency of the incident photons. When an incident photon collides with a molecule, energy may be transferred from the photon to the molecule, or from the molecule to the photon. When energy is transferred from the photon to the molecule, the scattered photon will then emerge from the sample having a lower energy and a corresponding lower frequency. These lower-energy Raman scattered photons are commonly referred to in Raman spectroscopy as the “Stokes radiation.” A small fraction of the analyte molecules are already in an energetically excited state. When an incident photon collides with an excited molecule, energy may be transferred from the molecule to the photon, which will then emerge from the sample having a higher energy and a corresponding higher frequency. These higher-energy Raman scattered photons are, commonly referred to in Raman spectroscopy as the “anti-Stokes radiation.”

The Stokes and the anti-Stokes radiation is detected by a detector, such as a photomultiplier or a wavelength-dispersive spectrometer, which converts the energy of the impinging photons into an electrical signal. The characteristics of the electrical signal are at least partially a function of the energy (or wavelength, frequency, wave number, etc.) of the impinging photons and the number of the impinging photons (intensity). The electrical signal generated by the detector can be used to produce a spectral graph of intensity as a function of frequency for the detected Raman signal (i.e., the Stokes and anti-Stokes radiation). By plotting the frequency of the inelastically scattered Raman photons against intensity, a unique Raman spectrum is obtained, which corresponds to the particular analyte. This Raman spectrum may be used for many purposes, such as identifying chemical species, identifying chemical states or bonding of atoms and molecules, and even determining physical and chemical properties of the analyte.

Since the intensity of the Raman scattered photons is low, very intense laser light sources are usually employed to provide the excitation radiation. Thus, Raman spectroscopy is an effective chemical analysis tool, but it typically uses a rather large and powerful laser light source to effectively identify a particular chemical species. For example, a typical Raman spectroscopy system occupies a large table and requires a significant amount of power for the laser light source. As a result, a typical Raman spectroscopy system is not portable and is expensive to build or purchase and operate.

### BRIEF DESCRIPTION OF THE DRAWINGS

The embodiments of the invention will be described in detail in the following description with reference to the following figures.

FIG. 1A is a sectional view of a light amplifying structure, according to an embodiment;

FIG. 1B is a sectional view of a light amplifying structure including spacers, according to an embodiment;

FIG. 1C is a perspective view of a light amplifying structure, according to an embodiment;

FIG. 2 is a is a sectional view of a light amplifying structure including Bragg mirrors, according to an embodiment;

FIG. 3 shows a sensor, according to an embodiment;

FIG. 4 shows a sensor with a variable sizer, according to an embodiment; and

FIG. 5 shows a graph illustrating intensity as a function of wavelength in a resonant cavity of the light amplifying structures described herein, according to an embodiment.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In some instances, well known methods and structures are not described in detail so as not to unnecessarily obscure the description of the embodiments. Also, the invention is described with respect to multiple embodiments. At least some of the embodiments may be practiced in combination.

According to an embodiment, a light amplifying structure includes a resonant cavity that has multiple resonant frequencies. For example, the resonant cavity is a Fabry-Perot resonant cavity or other type of resonant cavity. Light emitted into the cavity is reflected internally within the resonant cavity. For certain frequencies of the light emitted into the cavity, the internally reflected light causes the intensity and power of radiated light inside the resonant cavity to increase to a maximum amount when compared to other frequencies of emitted light. The frequencies causing the maximum intensity and power of radiated light inside the resonant cavity are the resonant frequencies of the cavities, which is further described below.

The light amplifying structure, according to the embodiment, is configured to amplify excitation light and radiated light at different resonant frequencies of the multiple resonant frequencies of the resonant cavity. The excitation light is light emitted into the resonant cavity from a light source, and the radiated light is light radiated from an analyte (e.g. sample to be tested) excited by the excitation light. The analyte includes a predetermined molecule determined to emit the radiated light at one of the resonant frequencies if excited by the excitation light. The predetermined molecule may be a specific molecule or species of molecules that are detectable through Raman spectroscopy because they have the same or similar detectable characteristics. For example, species A is detectable because the molecules in species A emit the same frequency or frequency range of radiated light when excited.

In one embodiment, the light amplifying structure is variable. For example, the size of the resonant cavity may be varied in response to a electronic signal or voltage, so the light amplifying structure can be modified on-the-fly for use to detect different predetermined molecules radiating light at different frequencies. In another embodiment, the size of the resonant cavity is not variable, and thus, the structure may be used in a sensor to detect one predetermined molecule, which may be a species or other group of molecules that radiate at the same resonant frequency.

### 1. Light Amplifying Structure

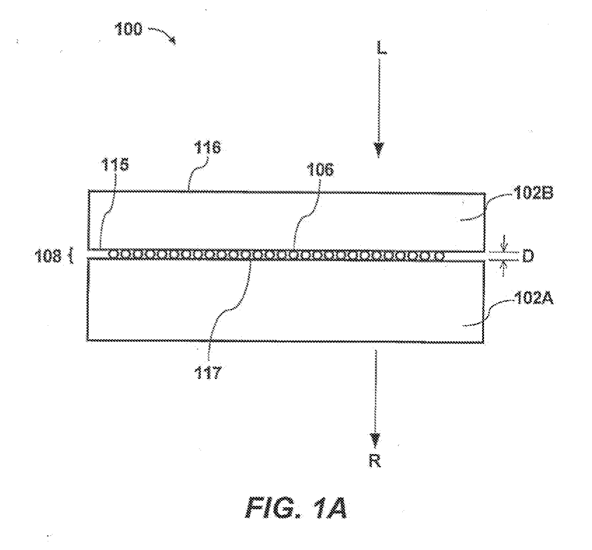

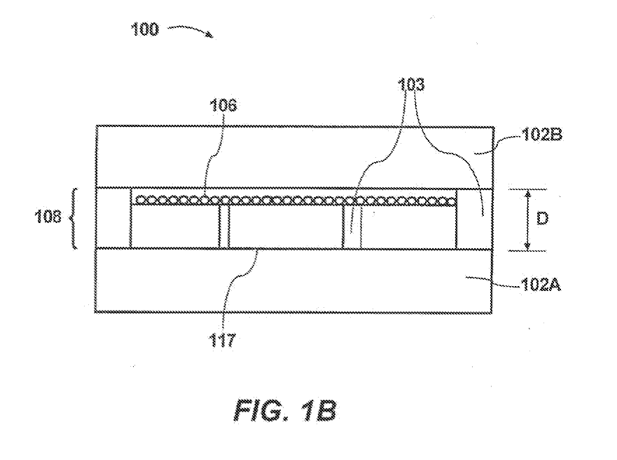

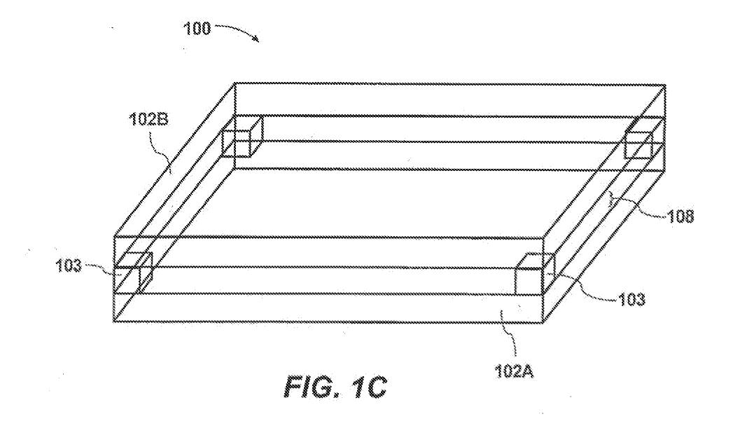

FIG. 1A illustrates a light amplifying structure 100, according to an embodiment. The light amplifying structure 100 includes a bottom layer 102A and a top layer 102B that are separated by a distance D to define a standoff or resonant cavity 108 therebetween. The top layer 102B has a lower surface 115 and an upper surface 116 that are generally parallel to each other. Note that the surfaces 115 and 116 may be concave, similar to a concave reflector in a laser cavity, but remain parallel. The bottom layer 102A has a face 117 opposing the lower surface 115 of the top layer 102B and is separated therefrom by the distance D. An analyte 106 may be provided in the resonant cavity 108 when performing Raman spectroscopy. The distance D may be as small as about a monolayer of the analyte 106 being analyzed or more.

The thickness of the bottom layer 102A and the top layer 102B may be between about 0.1 microns and about 10 millimeters. The length and width of the bottom layer 102A and the top layer 102B are not critical, but may be sized to allow the structure 100 to be handled manually, for example, with tweezers or any other suitable micromanipulator device. The bottom layer 102A and the top layer 102B may be formed from a variety of different materials. Materials for the bottom layer 102A and the top layer 102B, for example, may include diamond, silicon nitride, silicon dioxide, or any other suitable material. However, the bottom layer 102A and the top layer 102B should be at least partially transparent to the wavelength of the incident excitation light to be used for spectroscopic analysis.

Reflective coatings (not shown) may be provided on the lower surface 115 of the top layer 102B and the opposing face 117 of the bottom layer 102A. Reflective coatings can be made from silver, diamond, or any other material that will at least partially reflect the incident radiation. The reflective coatings may cause more light to reflect internally inside the cavity, instead of being transmitted through the layers 102A or 102B (which may be dielectric layers), thereby further increasing the intensity of the light resonating within the cavity 108.

Referring to FIG. 1B, a predetermined amount of standoff between the bottom layer 102A and the top layer 102B may be provided by including spacer elements 103, also referred to as spacers. As shown in FIG. 1C, a plurality of spacer elements 103 may be used, one spacer element being located at each of the corners of the bottom layer 102A and the top layer 102B. As an example, the spacer elements 103 may include epoxy pillars, that bond the opposing surfaces of the bottom layer 102A and the top layer 102B together. Alternatively, the spacer elements 103 may include bricks of solder stenciled or screened onto metallic pads (not shown) on the opposing surfaces of the bottom layer 102A and the top layer 102B. The bottom layer 102A and the top layer 102B then may be heated to re-flow the solder, thereby bonding the layers together. Alternatively, the spacer elements 103 may include preformed glass pillars that are bonded to or formed on at least one of the opposing surfaces of the bottom layer 102A and the top layer 102B at the corners thereof. If spacer elements 103 are bonded to the top and bottom layers, an adhesive (e.g., an epoxy or any other suitable adhesive) may be used to bond the materials together. Spacer elements also may be formed directly on the face 117 of the bottom layer 102A.

The bottom layer 102A, the top layer 102B, and any spacer elements 103 may be formed separately and attached or secured together, or may be formed separately and merely held together by gravity or weak inter-atomic forces. Alternatively, the bottom layer 102A, the top layer 102B, and any spacer elements 103 may be formed layer-by-layer as a monolithic structure using conventional microelectronic fabrication techniques.

The analyte 106 may be provided within the resonant cavity 108 by manually placing the analyte 106 within the resonant cavity 108, or by diffusing the analyte 106 into the resonant cavity 108.

The light amplifying structure and other structures, devices, and methods described herein may be used for Raman spectroscopy to analyze and/or identify a molecule, a molecule species, identifying chemical states or bonding of atoms and molecules, and determining physical and chemical properties of the analytes. In one embodiment, the Raman spectroscopy is Surface Enhanced Raman Spectroscopy (SERS), which has been developed to increase the Raman signal produced by an analyte and to allow surface studies of the analyte. In SERS, the analyte molecules are adsorbed onto or positioned near a specially roughened metal surface. Typically, the metal surface is made from gold, silver, copper, platinum, palladium, aluminum, or other metals or metal alloys. SERS has also been performed employing metallic nanoparticles or nanowires for the metal surface, as opposed to a roughened metallic surface. In SERS, more photons are inelastically scattered by the analyte molecules when compared to conventional Raman spectroscopy. In this embodiment, the light amplifying structure 100 may have metallic nanoparticles or nanowires or a roughened metallic surface for the surfaces 115 or 117. Alternatively, a SERS structure may be provided in the resonant cavity 108, such as disclosed in U.S. Pat. No. 7,339,666 by Wang et al., which is incorporated by reference in its entirety.

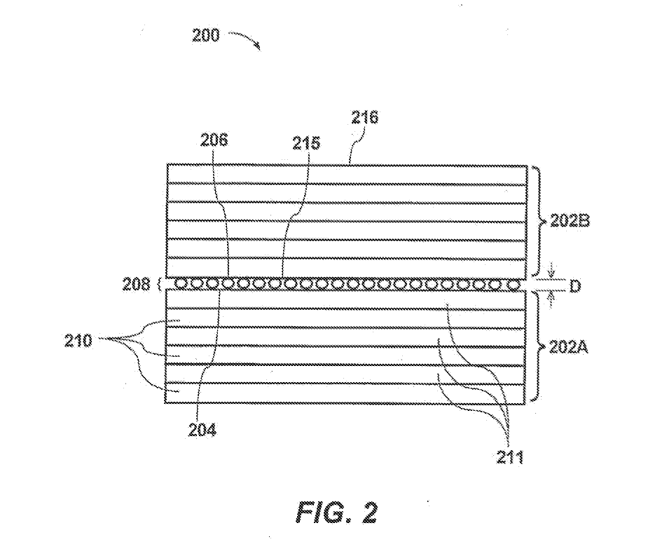

FIG. 2 illustrates a light amplifying structure 200 including spacers, according to an embodiment. The light amplifying structure 200 includes a bottom layer 202A and a top layer 202B that are separated by a distance D to define a standoff or resonant cavity 208 therebetween. The top layer 202B has a lower surface 215 and an upper surface 216 that are generally parallel to each other. Bottom layer 202A has a face 217 opposing the lower surface 215 of the top layer 202B and is separated therefrom by a distance D. An analyte 206 may be provided in the cavity 208 when performing Raman spectroscopy. The distance D may be as small as about a monolayer of the analyte 206 being analyzed or more.

The bottom layer 202A and the top layer 202B of the light amplifying structure 200 may include Bragg mirrors, which may be used as the material layers in the cavity 208, for example, as part of a Fabry-Perot resonator. Bragg mirrors are highly reflective structures and may have a reflectivity as high as about 99.99%. Bragg mirrors include a multilayer stack of alternating layers of high and low refractive index material, shown in FIG. 2 as low-index layers 210 and high-index layers 211. Reflectivity generally increases with the number of pairs of alternating layers. In the illustrated embodiment, the top layer 202B and the bottom layer 202A each comprise three pairs of layers. However, the top layer 202B and the bottom layer 202A may comprise from one to about sixty pairs of layers, and either the top layer 202B or the bottom layer 202A may comprise more or less pairs of layers than the other layer.

The thickness of each layer may be selected to be approximately one-fourth the wavelength of the incident light divided by the refractive index of the material from which the layer is formed (λ/4nᵣᵢ, where λ is the wavelength of the incident light and nᵣᵢ is the refractive index of the material).

Raman spectroscopy may be performed using excitation light at wavelengths between about 350 nanometers (nm) and about 1000 nm. Therefore, as an example, if the incident excitation light were to have a wavelength of 800 nm, and the refractive index of the low-index layers 210 and the high-index layers 211 were 2, the thickness of the low-index layers 210 and the high-index layers 211 may be approximately 100 nm. In this configuration, the total thickness of the bottom layer 202A and the top layer 202B would be approximately 600 nm (6 layers each having a thickness of 100 nm), and the distance D could be selected to be 400 nm, 1200 nm, 1600 nm, 2000 nm, 8000 nm, etc. (i.e., any integer multiple of one half of 800 nm). In another example, if λ is 800 nm and nᵣᵢ of the low-index layers 210 is 1.5, then the thickness of the low-index layers 210 may be approximately 133 nm. As described above, the thickness of the high-index layers 211 may be approximately 100 nm if nᵣᵢ of the high-index layers 211 is 2.

The low-index layers 210 and the high-index layers 211 of the Bragg mirrors may be formed from a variety of materials. As an example, the high-index layers 211 may be formed from GaAs and the low-index layers 210 of AlGaAs. Other examples of suitable material combinations for low-index layers 210 and high-index layers 211 include, but are not limited to: Si and SiO₂; AlGaAs layers having alternating atomic percents of Al and Ga; GaN and GaAlN; and GaInAsP and InP. Many such suitable material pairs are known in the art and are intended to be included within the scope of the invention.

The resonant cavity 208 defined by the bottom layer 202A and the top layer 202B of the light amplifying structure 200 may include a Fabry-Perot resonant cavity, and may operate in the same manner discussed previously in relation to the light amplifying structure 100 of FIG. 1A.

According to an embodiment, the resonant cavity layer in the light amplifying structure, which includes the cavities 108 and 208, may be comprised of photonic crystals instead of a conventional Fabry-Perot resonator. When the periodicity in refractive index in a photonic crystal is interrupted, perhaps by a defect or a missing layer in a Bragg mirror (which may be comprised of single dimension photonic crystals), certain defect modes may be generated. A defect may be generated within a photonic crystal by, for example, changing the refractive index within the crystal at a specific location, changing the size of a feature in the crystal, or by removing one feature from the periodic array within the crystal. Defect modes allow certain frequencies of light within the band gap to be partially transmitted through the crystal and enter into the defect area where the photons of the radiation are at least partially trapped or confined. As more photons enter the defect and become trapped or confined, the light intensity may be increased within the cavity, providing a similar intensity amplifying effect as that produced by a Fabry-Perot resonant cavity.

The frequencies associated with the defect modes are, at least partially, a function of the dimensions of the defect. The finite-difference time-domain method may be used to solve the full-vector time-dependent Maxwell's equations on a computational grid including the macroscopic dielectric function, which will be at least partially a function of the feature dimensions, and corresponding dielectric constant within those features, of the photonic crystal to determine which wavelengths may be forbidden to exist within the interior of any given crystal, and which wavelengths will give rise to a defect mode at the location of a defect within the crystal.

Features of the embodiments of the light amplifying structures described herein including the bottom layer, the top layer, spacer elements, cavity layers, and Bragg mirror layers may be formed using conventional microelectronic fabrication techniques on a support substrate such as, for example, a silicon wafer, partial wafer, or a glass substrate. Examples of techniques for depositing material layers include, but are not limited to, molecular beam epitaxy (MBE), atomic layer deposition (ALD), chemical vapor deposition (CVD), physical vapor deposition (PVD), sputter deposition and other known microelectronic layer deposition techniques. Photolithography may also be used to form structures in layers, such as a cavity in a cavity layer. Examples of techniques that can be used for selectively removing portions of the layers include, but are not limited to, wet etching, dry etching, plasma etching, and other known microelectronic etching techniques. These techniques are known in the art and will not be further described herein.

If desired, the bottom layer and the top layer of the light amplifying structures disclosed herein may be formed on a support substrate such as, for example, a silicon wafer, partial wafer, or a glass substrate. A portion of the support substrate may then be removed, for example, by way of etching, to expose the bottom layer or the top layer. If the support substrate is optically transparent for the wavelengths of the excitation light, none of the support substrate needs to be removed.

In addition, each of the bottom layer, top layer, spacer elements, cavity layers, and Bragg mirror layers may be formed separately and assembled together, or alternatively, two or more of the structures may be formed together, for example, by forming one layer or element on top of another layer or element.

### 2. Operation of the Light Amplifying Structure

Operation of the light amplifying structure 100 is now described with reference to FIG. 1A. In one embodiment, the resonant cavity 108 is a Fabry-Perot resonant cavity. A simple Fabry-Perot resonant cavity may include two parallel, flat, material layers. The bottom layer 102A and top layer 102B function as the material layers of a Fabry-Perot resonator. The Fabry-Perot resonant cavity, e.g., 108, is defined between the bottom layer 102A and the top layer 102B. The layers have a refractive index (or dielectric constant) different from that of the resonant cavity 108. When light impinges on the upper surface 116 of the top layer 102B in the direction illustrated by direction arrow L in FIG. 1A, at least some of the radiation may pass through the top layer 102B into the resonant cavity 108. The change or difference in refractive index at the interfaces between the bottom layer 102A and the cavity 108, and between the top layer 102B and the cavity 108, may cause at least some of the radiation to be reflected internally within the resonant cavity 108 rather than being transmitted through the layers.

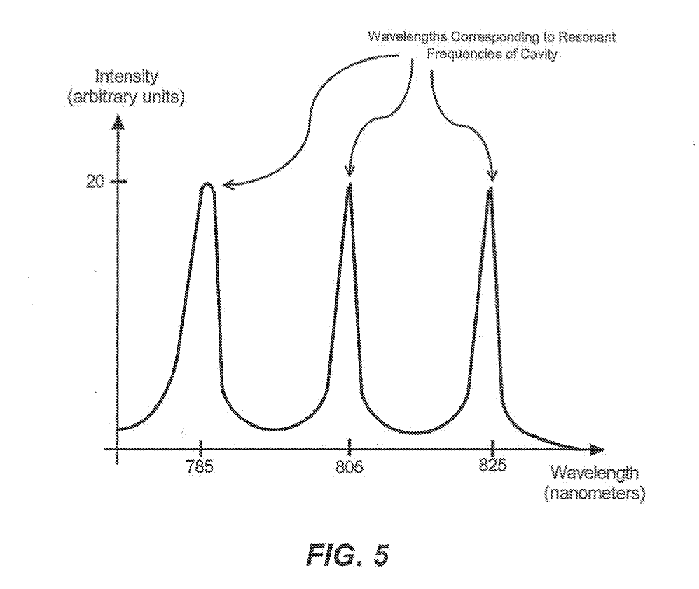

When the distance D separating the bottom layer 102A and the top layer 102B is equal to an integer number of half wavelengths of the radiation, the internally reflected radiation may interfere constructively, causing the intensity and power of the radiation inside the resonant cavity 108 to increase. Amplification includes increasing the amplitude of the signal. When the distance D is not equal to an integer number of half wavelengths of the excitation radiation, the internally reflected light may interfere destructively, causing the intensity of the light inside the resonant cavity 108 to be diminished, which may render the light amplifying structure 100 ineffective for performing Raman spectroscopy. Therefore, for a Fabry-Perot resonant cavity having a distance D, a graph of the intensity of radiation within the resonant cavity as a function of the frequency of the incident radiation may produce a spectrum or plot having a series of peaks corresponding to the resonant frequencies (or resonant modes) of the cavity, similar to that shown by the graph in. FIG. 5. The peaks correspond to wavelengths that satisfy the equation λ=2D/n, where λ is the wavelength of the incident radiation and n is an integer. For example, the wavelengths of the peaks may be 785 nm, 805 nm, and 825 nm, and the intensity of the peaks may be 20 arbitrary units (au). These values are examples, and the values may be different for different designs. Also, the resonant frequencies shown in FIG. 5 correspond to longitudinal resonant modes of the resonant cavity. There are also lateral resonant modes. Those modes include peaks similar to shown in FIG. 5 but with slightly shifted peak locations due to the different lateral optical field distribution (basic and higher order Gaussian beams).

As a result, the distance D is selected based upon the wavelength of the excitation light in order to increase the intensity of the radiation in the cavity. For example, if the excitation light is to have a wavelength of 800 nm, then the distance D may be an integer multiple of 400 nm. Therefore D could be 400 nm, 1200 nm, 1600 nm, 2000 nm, 8000 nm, etc.

When the condition for resonance is satisfied, the intensity of the excitation light may be increased within the resonant cavity 108 by a factor of about 1000. Therefore, as an example, if the power of the excitation light is 1 milliwatts (mW), the power of the radiation resonating within the resonant cavity 108 may be about 1 (Watt) W. In addition, because the intensity of the radiation inside the resonant cavity can be very high, non-linear effects, such as second harmonic generation, may be appreciable, resulting in increased performance of the light amplifying structure 100. The intensity of the light within the resonant cavity 108 may vary with position. Therefore, the analyte 106 may be positioned at the area of highest intensity within the resonant cavity 108. Alternatively, the analyte 106 could be positioned so as to maximize the ratio of the energy stored in the resonant cavity 108 to the energy outside the cavity (i.e., maximize the quality factor (Q-factor) of the cavity).

### 3. Resonant Cavity Configured for Excitation Light and Radiated Light to be at Resonant Frequencies of the Resonant Cavity

FIG. 5 shows the resonant cavity 108 may have multiple resonant modes, corresponding to the peaks shown in FIG. 5. Conventionally, the resonant cavity is not designed so the light radiated from the analyte, referred to as the radiated light, is at one of the resonant frequencies of the cavity, which corresponds to one of the peaks shown in FIG. 5. According to an embodiment, the resonant cavity is designed so that the excitation light, shown as coming from the source L in FIG. 1A, and the radiated light, shown as R in FIG. 1A, are both at resonant frequencies of the cavity 108, which may be two different resonant frequencies of the cavity 108. In one embodiment, various design variables of the structure are selected in order to accommodate the resonant frequency of the radiated light emitted by a predetermined molecule to be detected. For example, if the wavelength of the frequency of radiated light emitted by molecule A is known to be 800 nm, then the resonant cavity is designed to amplify at that wavelength so a resonant frequency of the cavity corresponds to the 800 nanometer wavelength. The excitation light is at a wavelength that corresponds to another resonant frequency of the resonant cavity. A tuneable laser or other light source may be used to generate the excitation light at the desired wavelength corresponding to a resonant frequency of the cavity. Examples of design variables that are selected may be selecting sizes of the spacers or other layers to control the distance D. Design variables may include length or thickness of layers or spacers, periodicity of holes if photonic crystals are used, size of the holes for photonic crystals, etc.

### 4. Variable Size Resonant Cavity

In one embodiment, once the design variables for the amplifying structure are selected, the amplifying structure is created and is not modifiable. Thus, the amplifying structure is designed to only amplify one set of frequencies corresponding to the resonant frequencies of the resonant cavity. In another embodiment, the size of the resonant cavity may be varied, on-the-fly, so the amplifying structure can be modified as needed, even after it is initially created, to correspond to different sets of resonant frequencies. This has the advantage of being able to use a single sensor including the variable size resonant cavity to detect different predetermined molecules. A variable sizer may be used to control the distance D. In one example, the variable sizer is a piezoelectric spacer whose size may be adjusted (causing the distance D to change) by applying a particular voltage. The spacers 103 shown in FIGS. 1B and 1C may be piezoelectric spacers. In another example, some other mechanism may be used to modify the distance D or some other design variable for tuning the amplifying structure to have a desired resonant frequency.

5. Sensor including Amplifying Structure

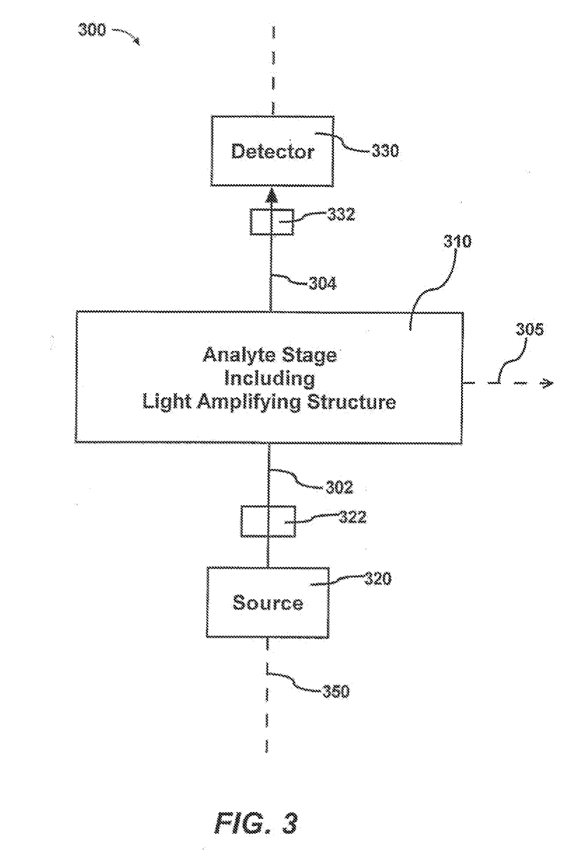

FIG. 3 shows a sensor 300, according to an embodiment. The sensor 300 includes a sample or analyte stage 310 that includes any one of the light amplifying structures disclosed herein, or an equivalent thereof, an excitation radiation or light source 320, and a detector 330. The sensor 300 may also include various optical components 322 between the light source 320 and the analyte stage 310, and various, optical components 332 between the analyte stage 310 and the detector 330.

The light source 320 may be any suitable light source configured for emitting light in the desired wavelength and, preferably, having a tunable wavelength. As an example, commercially available semiconductor lasers, helium-neon lasers, carbon dioxide lasers, light emitting diodes, incandescent lamps, and many others may be used as the light source 310. The wavelengths that are emitted by the light source 320 may be any suitable wavelength for properly analyzing the analyte contained within the light amplifying structure of the analyte stage 310. As an example, a representative range for the wavelengths that may be emitted by the light source 320 includes frequencies from about 350 nm to about 1000 nm.

The light 302 from the light source 320 is the excitation light. The excitation light 302 may be delivered directly from the light source 320 to the analyte stage 310, which contains the analyte. Alternatively, collimation, filtration, and subsequent focusing of the excitation light 302 with optical components 322 may be performed before the excitation light 302 impinges on a surface of the light amplifying structure of the analyte stage 310. The light amplifying structure of the analyte stage may be oriented in any direction relative to the impinging excitation light 302 that allows the light to be amplified within the light amplifying structure, and for example is oriented so that the light impinges on either a top layer or bottom layer of the light amplifying structure in a direction perpendicular thereto (e.g., in the direction L shown in FIG. 1A).

The light amplifying structure of the analyte stage 310 increases the intensity of the excitation light 302 within its resonant cavity, as discussed previously with respect to each of the embodiments, such as when the excitation light is at a resonant frequency of the resonant cavity. This amplified excitation light impinges on the analyte disposed in the resonant cavity. The amplified excitation light excites the molecules in the analyte, and the molecules radiate inelastically as scattered Stokes or anti-Stokes radiation (or both) to produce Raman scattered photons, shown as the radiated light 304. As described above, the resonant cavity of the light amplification structure is designed to amplify the radiation light 304 as well as the excitation light 302 if the lights 302 and 304 are at the resonant frequencies of the cavity. In other words, the resonant cavity of the light amplification structure is designed to be used to detect a specific molecule or species that is known to emit a radiation light at a predetermined frequency. So, if the predetermined frequency of the radiation light for the particular molecule corresponds to an 800 nm wavelength, then the resonant cavity is designed to amplify at that wavelength. Alternatively, a variable sizer is used to modify the resonant cavity to amplify the radiation light 304 at that wavelength.

The Raman scattered photons (i.e., radiated light 304) scattered by the analyte or sample may be collimated, filtered, or focused with optical components 332. For example, a filter or a plurality of filters may be employed, either included, with the structure of the detector 330, or as a separate unit that is configured to filter the wavelength of the light 302 from the light source 320, thus allowing only the Raman scattered photons to be received by the detector 330.

The detector 330 receives and detects the Raman scattered photons and may include a monochromator (or any other suitable device for determining the wavelength of the radiated light 304) and a device such as, for example, a photomultiplier for determining the quantity or number of the emitted Raman scattered photons (intensity). The detector 330 may also be positioned on the same side of the analyte stage 310 as the light source 320 to receive radiated light 304.

Ideally, the Raman scattered photons are isotropic, being scattered in all directions relative to the analyte stage 310. Thus, the position of detector 330 relative to the analyte stage 310 is not particularly important. However, the detector 330 may be positioned at, for example, an angle of 90 degrees relative to the direction of the incident light 302 (shown as dashed line 305) to minimize the intensity of the incident light 302 that may be incident on the detector 330.

In another embodiment, the wave vector of the incident light 302 may be slightly off-axis relative to the reference axis 350 and the detector 330 positioned to receive the Raman-scattered photons having a wave vector parallel to the reference axis 350. In such a configuration, the light 302 from the light source 320 will be substantially filtered and the detector 330 will only receive the Raman-scattered photons.

Because the intensity of the incident light 302 and the radiated light 304 is increased or amplified within the light amplifying structures of the analyte stage 310, the light source 320 need not be as powerful as those required in conventional Raman spectroscopy systems. This, in turn, enables the sensor 300 to be smaller and portable compared to the relatively large conventional sensors and consumes less power. Furthermore, the sensor 300 is capable of performing more sensitive chemical analysis because the radiated light 304 is amplified.

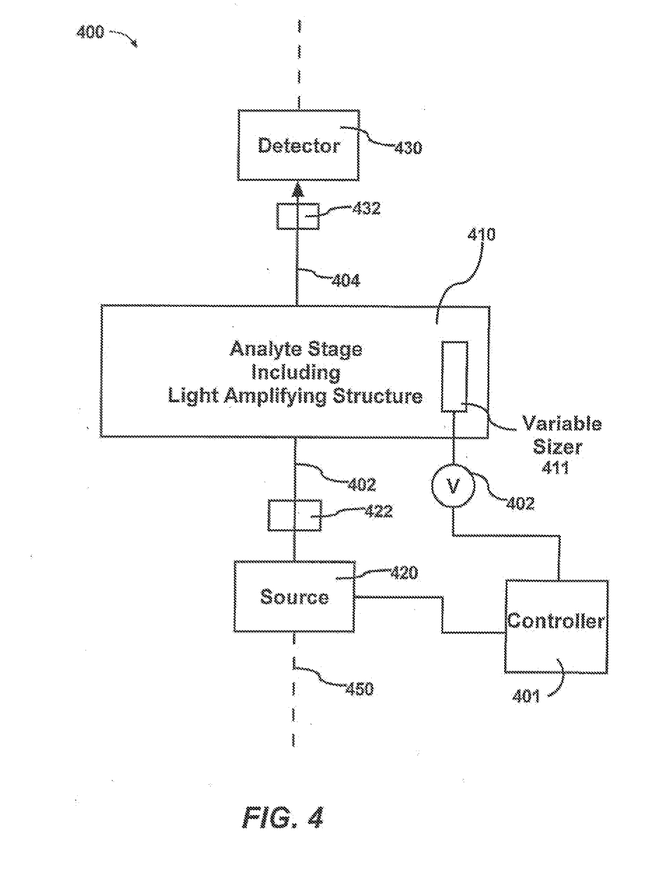

FIG. 4 illustrates another embodiment of a sensor 400 wherein the resonant cavity may be sized on-the-fly to provide different resonant frequencies to detect different molecules or species. The sensor 400 is similar to the sensor 300. The sensor 400 includes an analyte stage 410, a light source 420, and a detector 430. The sensor 400 may also include various optical components 422. These components perform the same as the corresponding components of the sensor 300 described above.

The sensor 400 also includes a controller 401, a voltage source 402, and a variable sizer 411. The variable sizer 411 is configured to change the distance D in the resonant cavity. In one embodiment, the variable sizer 411 comprises a piezoelectric spacer that is configured to change its size and the distance by applying a voltage to the spacer from the voltage source 402. The voltage source 402 may be controlled by the controller 401 to apply different voltages as needed so the spacer changes to the appropriate size.

For example, the controller 401 receives a selection that indicates the sensor 400 is to detect species A. It is known that species A, when excited in the resonant cavity by the excitation light, emits a radiated light in the resonant cavity at a wavelength of 800 nm. The controller 401 accesses a stored voltage value that adjusts the size of the variable sizer 411 so the resonant cavity has a resonant frequency corresponding to 800 nm. The controller 401 controls the voltage source 402 to apply the voltage for the species A. Now the sensor is tuned to detect the species A. At a later time, the sensor 400 is tuned to detect species B. For example, the controller 401 receives a selection for species B. The controller 401 accesses a voltage value that adjusts the size of the variable sizer 411 so the resonant cavity has a resonant frequency corresponding to the wavelength of the radiated light of the species B. The controller 401 controls the voltage source 402 to apply the voltage for the species B.

The controller 401 may also control the light source 420 to adjust the excitation light output from the light source 420 to the desired frequency. For example, the controller 401 controls the light source 420 to adjust the excitation light to a resonant frequency of the resonant cavity, which may be determined based on the type of species or molecule to be detected as described above. Note that the resonant cavity may have multiple resonant frequencies, so if the resonant cavity is adjusted for the 800 nm radiated light for species A, the resonant cavity may have another resonant frequency, for example, at 785 nm. Then, the light source 420 is controlled to generate the excitation light at 785 nm.

While the embodiments have been described with reference to examples, those skilled in the art will be able to make various modifications to the described embodiments. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A light amplifying structure 100 for Raman spectroscopy, comprising:
a first portion 102B having a first surface and an opposing second surface;
a second portion 102A having a face opposing the first surface of the first portion with a resonant cavity 108 provided therebetween; and
a distance in the resonant cavity 108 between the first portion 102B and the second portion 102A configures the resonant cavity 108 to amplify light at a first resonant frequency and a second resonant frequency, wherein excitation light emitted from a light source into the resonant cavity is configured to be at the first resonant frequency, and radiated light radiated from a predetermined molecule excited by the excitation light in the resonant cavity 108 is radiated at the second resonant frequency.

2. The light amplifying structure 100 of claim 1, further comprising:
a variable sizer 411 configured to change the distance in the resonant cavity 108 between the first portion 102B and the second portion 102A, wherein the changed distance configures the resonant cavity 108 to amplify light at a new first resonant frequency and a new second resonant frequency, and
excitation light emitted from the light source into the resonant cavity 108 at the new first resonant frequency excites a different second predetermined molecule in the resonant cavity 108 to radiate light at the new second resonant frequency.

3. The light amplifying structure 100 of claim 2, wherein the variable sizer 411 comprises a spacer 103 between the first portion 102B and the second portion 102A that changes size to variably control the distance between the first portion 102B and the second portion 102A.

4. The light amplifying structure 100 of claim 3, wherein the spacer 103 comprises a piezoelectric spacer that is configured to change its size and the distance by applying a voltage to the spacer.

5. The light amplifying structure 100 of claim 1, wherein the first portion 102B and the second portion 102A of the light amplifying structure each comprise a Bragg Mirror.

6. The light amplifying structure 100 of claim 1, wherein the light amplifying structure 100 further comprises a cavity layer disposed between the first portion 102B and the second portion 102A, the cavity layer including photonic crystal and having a defect cavity.

7. The light amplifying structure 100 of claim 1, wherein the resonant cavity 108 is a Fabry-Perot resonant cavity.

8. A sensor 300 configured to detect one or more predetermined molecules, the sensor 300 comprising:
a light amplifying structure 100 for Raman spectroscopy, the light amplifying structure including
a first portion 102B having a first surface and an opposing second surface;
a second portion 102A having a face opposing the first surface of the first portion with a resonant cavity 108 provided therebetween; and
a distance in the resonant cavity 108 between the first portion 102B and the second portion 102A configures the resonant cavity 108 to amplify light at a first resonant frequency and a second resonant frequency;
a light source 320 configured to emit excitation light into the resonant cavity 108 at the first resonant frequency; and
a detector 330 configured to detect radiated light at the second resonant frequency, wherein a predetermined molecule in the resonant cavity 108 that is excited by the excitation light at the first resonant frequency radiates the radiated light at the second resonant frequency.

9. The sensor 300 of claim 8, wherein the light amplifying structure 100 further comprises:
a variable sizer 411 configured to change the distance in the resonant cavity 108 between the first portion 102B and the second portion 102A, wherein the changed distance configures the resonant cavity to amplify light at a new first resonant frequency and a new second resonant frequency, and
excitation light emitted from the light source 320 into the resonant cavity 100 at the new first resonant frequency excites a different second predetermined molecule in the resonant cavity 108 to radiate light at the new second resonant frequency.

10. The sensor 300 of claim 9, further comprising:
a controller 401 configured to control the variable sizer 411 to change the distance to detect a selected predetermined molecule.

11. The sensor 300 of claim 10, wherein the controller controls the light source 420 to tune the excitation light to a resonant frequency of the resonant cavity 108.

12. The sensor 300 of claim 9, wherein the variable sizer 411 comprises a spacer 103 between the first portion 102B and the second portion 102A that changes size to variably control the distance between the first portion 102B and the second portion 102A.

13. The sensor 300 of claim 12, wherein the spacer 103 comprises a piezoelectric spacer that is configured to change its size and the distance by applying a voltage to the spacer 103.

14. The sensor 300 of claim 8, wherein the first portion 102B and the second portion 102A of the light amplifying structure 100 each comprise a Bragg Mirror.

15. A method of performing Raman spectroscopy for one or more predetermined molecules using a light amplifying structure 100 for Raman spectroscopy, the light amplifying structure 100 including a first portion 102B having a first surface and an opposing second surface; a second portion 102A having a face opposing the first surface of the first portion with a resonant cavity 108 provided therebetween; and a distance in the resonant cavity 108 between the first portion 102B and the second portion 102A configures the resonant cavity 108 to amplify light at a first resonant frequency and a second resonant frequency, the method comprising:
determining a predetermined molecule to detect;
determining the distance based on the predetermined molecule;
controlling a variable sizer 411 to provide the distance in the resonant cavity;
emitting an excitation light into the resonant cavity 108 at the first resonant frequency, wherein the predetermined molecule is in the resonant cavity 108; and
detecting radiated light from the predetermined molecule at the second resonant frequency.
